(19) United States
(12) Patent Application Publication
(10) Pub. No.: US 2019/0387739 A1
(43) Pub. Date: Dec. 26, 2019

(54) HERBICIDAL COMBINATION CONTAINING TRIAFAMONE AND INDAZIFLAM

(71) Applicant: Bayer CropScience Aktiengesellschaft, Monheim am Rhein (DE)

(72) Inventors: Joerg OESER, Muelheim An Der Ruhr (DE); Ramisis FULGENCIO, Duesseldorf (DE); Christopher Hugh ROSINGER, Hofheim (DE); Juergen ECHLE, Leichlingen (DE)

(21) Appl. No.: 16/467,004

(22) PCT Filed: Nov. 30, 2017
(86) PCT No.: PCT/EP2017/080954

§ 371 Date: Jun. 5, 2019

(30) Foreign Application Priority Data
Dec. 7, 2016 (EP) 16202559.7

(51) Int. Cl. A01N 43/66; A01N 43/68

(52) U.S. Cl. CPC A01N 43/66; A01N 43/68

(57) ABSTRACT

The invention relates to a herbicide combination containing components (A) and (B) where
(A) being the compound and the salts thereof described by formula (A):

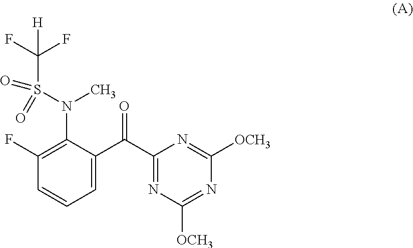 [SMILES: COc1nc(OC)nc(C(=O)c2cccc(F)c2N(C)S(=O)(=O)C(F)F)n1]

and
(B) being the compound and stereoisomers thereof described by formula (B):

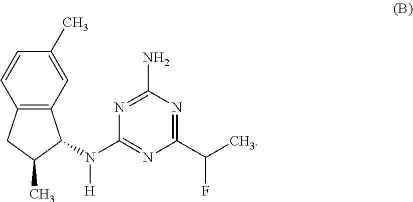 [SMILES: Cc1ccc2c(c1)[C@H](Nc1nc(N)nc(C(C)F)n1)[C@@H](C)C2]

### DESCRIPTION

The present invention is in the technical field of crop protection compositions which can be used against unwanted vegetation, for example by the pre-sowing method, by the pre-emergence method (in each case with or without incorporation) or by the post-emergence method in sown and/or planted crop plants, for example in wheat, maize, soya bean, sugar beet, sugar cane, cotton, rice, beans, flax, barley, oats, rye, triticale, oilseed rape, potato, millet, meadow grass, greens/lawns, in permanent crops and/or on areas of permanent crops (fruit plantations and plantation crops) or on non-crop areas (for example squares of residential areas or industrial sites, railway installations). In addition to the single application, sequential applications are also possible.

It relates to a herbicide combination comprising at least two herbicides and to their use for controlling unwanted vegetation, in particular a herbicide combination comprising a compound from the group of the N-{2-[4,6-dimethoxy-(1,3,5)triazine-2(-carbonyl- or -hydroxymethyl)]-6-halophenyl}difluoromethanesulfonamides or their N-methyl derivatives and/or their salts, hereinbelow also referred to as “dimethoxytriazinyl-substituted difluoromethanesulfonylanilides”, and a further herbicidally active compound.

It is known that cyclicly substituted sulfonamides have herbicidal properties (for example WO 93/09099 A2, WO 96/41799 A1). These also include the phenyldifluoromethanesulfonamides, which are also referred to as difluoromethanesulfonylanilides. The last mentioned compounds are, for example, phenyl derivatives which are mono- or polysubstituted, inter alia by dimethoxypyrimidinyl (for example WO 00/006553 A1, JP 2000-63360, JP11-060562) or dimethoxytriazinyl and also a further halogen substitution (for example WO 2005/096818 A1, WO 2007/031208 A2).

However, specific compounds from the group of the N-{2-[4,6-dimethoxy-(1,3,5)triazine-2(-carbonyl- or -hydroxymethyl)]-6-halophenyl}difluoromethanesulfonamides, as described in WO 2005/096818 A1, and their N-methyl derivatives, as described for the first time in WO 2006/008159 A1 in connection with fungicides and in WO 2007/031208 A2 and WO 2009/024251 A2 as herbicides, are not entirely satisfactory in all respects with regard to their herbicidal properties.

The herbicidal activity of the dimethoxytriazinyl-substituted difluoromethanesulfonylanilides against harmful plants (broad-leaved weeds, weed grasses, cyperaceae; hereinbelow together also referred to as “weed”) is already on a high level, but generally depends on the application rate, the respective preparation form, the respective harmful plants to be controlled or the spectrum of harmful plants, the climatic and soil conditions, etc. Further criteria in this context are duration of action, or the breakdown rate, of the herbicide, the general crop plant compatibility and speed of action (more rapid onset of action), the activity spectrum and behaviour toward follower crops (replanting problems) or the general flexibility of application (control of weeds in their various growth stages).

With respect to the use for controlling harmful plants or unwanted vegetation in permanent crops or on areas of permanent crops (fruit plantations, plantation crops), there may be the following potential disadvantages: (a) no or insufficient herbicidal activity against certain harmful plants; (b) insufficient breadth of the spectrum of harmful plants that can be controlled; (c) inadequate selectivity in (young) plantation crops, which may lead to unwanted damage and/or reduced harvest yields; (d) initial herbicidal activity is not strong enough and/or (e) does not last long enough.

Also to be taken into account are, if appropriate, changes in the susceptibility of harmful plants which may occur on prolonged use of the herbicides or in a geographically restricted manner (control of tolerant or resistant weed species), for example in cereals, rice and maize, but also in potatoes, sunflowers, peas, carrots and fennel, for example in the case of ‘Target-Site Resistance’ (abbreviation: TSR; where the weed populations comprise biotypes having a target-site-specific resistance, i.e. the binding site at the site of action is modified as a result of natural mutations in the gene sequence so that the active compounds are no longer able to bind, or bind in an unsatisfactory manner, and are therefore no longer able to act) and enhanced metabolic resistance (abbreviation: EMR; where the weed populations comprise biotypes having a metabolic resistance, i.e. the plants are capable of metabolizing the active compounds more quickly via enzyme complexes, that means the active compounds are degraded more rapidly in the plant). The compensation of losses in action in the case of individual plants by increasing the application rates of the herbicides is only possible to a certain degree, for example because such a procedure reduces the selectivity of the herbicides or because the action is not improved, even when applying higher rates.

Thus, there is frequently a need for targeted synergistic activity against specific harmful plant species, control of harmful plants with better overall selectivity, generally lower amounts of active compounds used for equally good control results and for a reduced active compound input into the environment to avoid, for example, leaching and carry-over effects. There is also a need for developing one-shot applications to avoid labour-intensive multiple applications, and also to develop systems for controlling the rate of action, where, in addition to an initial rapid control of weeds, there is also a slow, residual control.

A possible solution to the problems mentioned above may be to provide herbicide combinations, that is mixtures of a plurality of herbicides and/or other components from the group of the agrochemically active compounds of a different type and of formulation auxiliaries and additives customary in crop protection which contribute the desired additional properties. However, in the combined use of a plurality of active compounds, there are frequently phenomena of chemical, physical or biological incompatibility, for example lack of stability in a joint formulation (coformulation), decomposition of an active compound or antagonism in the biological activity of the active compounds. For these reasons, potentially suitable combinations have to be selected in a targeted manner and tested experimentally for their suitability, it not being possible to safely discount a priori negative or positive results.

Mixtures of non-N-methyl derivatives of the compounds mentioned above are known in principle (for example WO 2007/079965 A2); however, their effectiveness in mixtures with other herbicides has only been confirmed in individual cases for dimethoxypyimidinyl-substituted phenyl derivatives. In addition, there are also mixtures of selected N-methyl derivatives of the above-mentioned compounds with some combination partners (e.g. WO 2008/101595 A2, WO 2010/017930 A2, WO 2010/017931 A2, WO 2010/017929 A1, WO 2010/017922 A2, WO 2010/017921 A2, WO 2010/017924 A2, WO 2010/017923 A2, WO 2010/017928 A1, DE 102008037630 A, WO 2010/017927 A2, WO 2010/017926 A2, WO 2010/017925 A2).

It was the object of the present invention to provide crop protection compositions as alternatives to the prior art, or as an improvement thereof, inter alia specifically with respect to:
a reduction in the number of applications, for example in permanent crops and on areas of permanent crops;
a more simple application method which reduces the costs for the user and would thus be more environmentally compatible;
an improvement in application flexibility of the active compounds from pre-emergence to post-emergence of the crop plants and harmful plants;
an improvement and application flexibility of the reliability of action on soils with different soil properties (e.g. soil type, soil humidity);
an improvement of the reliability of action to resistant species of harmful plants which would allow a novel option for an effective resistance management;
a more reliable control of problematic harmful plants such as Cyperaceae (Cyperus spp., Carex spp.).

Surprisingly, it has now been found that this object can be achieved by the combination of triafamone, a herbicide from the group of the N-methyl derivatives of the dimethoxytriazinyl-substituted difluoromethanesulfonylanilides, with the herbicidal compound indaziflam, which act together in a particularly favourable manner; for example when used for the control of unwanted vegetation in sown and/or planted crop plants such as wheat (durum and bread wheat), maize, soya bean, sugar beet, sugar cane, cotton, rice (planted or sown under upland or paddy conditions with Indica and/or Japonica species and also hybrids/mutants/GMOs), beans (such as, for example, bush bean and broad bean), flax, barley, oats, rye, triticale, oilseed rape, potato, millet (sorghum), meadow land, greens/lawns, in permanent crops and on areas of permanent crops (fruit plantations and plantation crops, for example pome and stone fruit, viticulture, hops, citrus trees, mango, olives, coffee, cacao, tea, soft fruit, banana, cooking banana, almond, walnut, pecan, hazelnut, pistachio trees, oil palms, rubber trees) or on non-crop areas (for example squares of residential areas or industrial sites, railway installations), preferably in permanent crops and on areas of permanent crops (fruit plantations and plantation crops, for example pome and stone fruit, viticulture, hops, citrus trees, mango, olives, coffee, cacao, tea, soft fruit, banana, cooking banana, almond, walnut, pecan, hazelnut, pistachio trees, oil palms, rubber trees) and in rice crops (planted or sown under upland or paddy conditions with Indica and/or Japonica species and also hybrids/mutants/GMOs), in particular in permanent crops and on areas of permanent crops.

Accordingly, the present invention provides a herbicide combination comprising components (A) and (B) where
(A) means the compound and/or its salts described by formula (A):

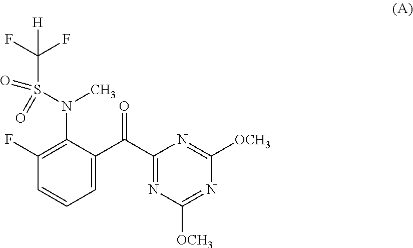 [SMILES: COc1nc(OC)nc(C(=O)c2cccc(F)c2N(C)S(=O)(=O)C(F)F)n1]

and
(B) means the compound and its stereoisomers described by formula (B):

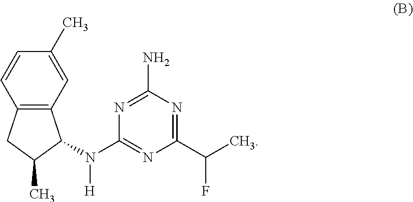 [SMILES: Cc1ccc2c(c1)[C@H](Nc1nc(N)nc(C(C)F)n1)[C@@H](C)C2]

Together, the herbicidally active constituents component A and B are hereinbelow referred to as “(individual) active compounds”, “(individual) herbicides” or as “herbicide components”, and they are known, as individual active compounds, for example from “The Pesticide Manual”, 16th edition 2012, where they are described in detail by their common name under the following entry numbers (abbreviation: “PM # . . . ” with the respective sequential entry number): component A as triafamone (PM # 880); component B as indaziflam (PM #498).

The formulae (A) and (B) mentioned and the use of the common names additionally include all possible application forms such as acids, salts, esters and isomers such as stereoisomers and optical isomers. Specifically embraced are all stereoisomers and their mixtures, in particular also racemic mixtures, and —if enantiomers are possible—the respective enantiomer which is biologically active. This also applies to possible rotamers. Salts may be formed by the action of a base on those compounds that bear an acidic hydrogen atom. Suitable bases are, for example, organic amines, such as trialkylamines, morpholine, piperidine or pyridine, and also ammonium, alkali metal or alkaline earth metal hydroxides, carbonates and bicarbonates, in particular sodium hydroxide and potassium hydroxide, sodium carbonate and potassium carbonate and sodium bicarbonate and potassium bicarbonate, alkali metal or alkaline earth metal alkoxides, in particular sodium methoxide, ethoxide, n-propoxide, isopropoxide, n-butoxide or t-butoxide or potassium methoxide, ethoxide, n-propoxide, isopropoxide, n-butoxide or t-butoxide. These salts are compounds in which the acidic hydrogen is replaced by an agriculturally suitable cation, for example metal salts, in particular alkali metal salts or alkaline earth metal salts, especially sodium salts and potassium salts, or else ammonium salts, salts with organic amines or quaternary ammonium salts, for example with cations of the formula [NRR′R″R′″]⁺ in which R to R′″ are in each case independently of one another organic radicals, in particular alkyl, aryl, arylalkyl or alkylaryl. Also suitable are alkylsulfonium and alkylsulfoxonium salts, such as (C₁-C₄)-trialkylsulfonium and (C₁-C₄)-trialkylsulfoxonium salts. The compounds of the formula (I) can also form salts by addition of a suitable inorganic or organic acid, for example mineral acids, for example HCl, HBr, H₂SO₄, H₃PO₄ or HNO₃, or organic acids, for example carboxylic acids such as formic acid, acetic acid, propionic acid, oxalic acid, lactic acid or salicylic acid, or sulfonic acids, for example p-toluenesulfonic acid, onto a basic group, for example amino, alkylamino, dialkylamino, piperidino, morpholino or pyridino. In such a case, these salts will comprise the conjugate base of the acid as the anion.

Component (A) is a compound from the group of the N-methyl derivatives of dimethoxytriazinyl-substituted difluoromethanesulfonylanilides and, in the literature cited above for this group, is described as an active compound alone and in combinations with other herbicides. The above-mentioned formula (A) characterizes and comprises, in addition to the compound, in particular also possible salts of triafamone.

Component (B) is a compound known as active compound for the control of unwanted vegetation (mainly by the pre-emergence method); see, for example, WO 97/31904 A, U.S. Pat. No. 6,069,114 B, WO 2004/069814 A, U.S. Pat. No. 8,114,991 B and the literature cited herein. Mixtures of indaziflam with other herbicides are known. CN 103329931 and the publications Weed Technology 2013, 27, 422-429 and The Horticultural Weed Control Report 2012 disclose specific combinations of indaziflam with glufosinate, while WO 2006/007947 A1 and WO 2010/009819 A2, for example, describe the combination of indaziflam with various compounds. The above-mentioned formula (B) characterizes and comprises, in addition to the compound, in particular also the stereoisomers of indaziflam

Hereinbelow, the terms “herbicide(s)”, “individual herbicide(s)”, “compound(s)” or “active compound(s)” or the appropriate common name are also used synonymously for the term “component(s)” in the context.

In one embodiment, the herbicide combination according to the invention comprises, as only herbicidally active compounds, the herbicides (A) and (B). In a preferred embodiment, in the composition for application, the herbicidally active compounds (A) an (B) coexist physically.

Additionally, in a further embodiment, the herbicide combination according to the invention of components (A) and (B) may comprise further components, for example agrochemically active compounds of a different type and/or the formulation auxiliaries and/or additives customary in crop protection, or may be used together with these. Hereinbelow, the use of the term “herbicide combination(s)” or “combination(s)” (according to the invention) also includes the “herbicidal compositions” (according to the invention) formed in this manner Conversely, when the term “herbicidal composition” (according to the invention) is used, reference is also made to the “herbicide combination(s)” or “combination(s)” (according to the invention).

In a preferred embodiment, the herbicide combination according to the invention comprises effective amounts of the herbicides (A) and (B) and/or has synergistic actions. The synergistic actions can be observed, for example, when the herbicides (A) and (B) are applied jointly, for example as a coformulation (composition) or as a tank mix. However, they can also be observed when the active compounds are applied at different times (split application, splitting). It is also possible to apply the herbicides or the herbicide combination in a plurality of portions (sequential application), for example pre-emergence applications followed by post-emergence applications or early post-emergence applications followed by medium or late post-emergence applications. Preference is given here to the joint or almost simultaneous application of the herbicides (A) and (B) of the combination in question, and the joint application is particularly preferred.

The synergistic effects permit a reduction of the application rates of the individual herbicides, a higher and/or longer efficacy at the same application rate, the control of species which were as yet uncontrolled (gaps), control of species which are tolerant or resistant to individual herbicides or to a number of herbicides, an extension of the period of application and/or a reduction in the number of individual applications required and—as a result for the user—weed control systems which are more advantageous economically and ecologically.

For example, the combination according to the invention of herbicides (A)+(B) allows the activity to be enhanced synergistically in a manner which, by far and in an unexpected manner, exceeds the activities which can be achieved using the individual herbicides (A) and (B).

If the abbreviation “AS/ha” is used in the present description, it means “active substance per hectare”, based on 100% active compound. All percentages in the description are percent by weight (abbreviation: “% by weight”) and, unless defined otherwise, refer to the relative weight of the respective component based on the total weight of the herbicidal composition (for example as formulation).

The application rate of the herbicide components and their derivatives in the herbicidal composition may vary within wide ranges. Applied at application rates of from 4-4100 g of AS/ha, the herbicide components control, when used in the pre-sowing, pre-planting or the pre- and post-emergence method, a relatively wide spectrum of harmful plants, for example of annual and perennial mono- or dicotyledonous broad-leaved weeds, weed grasses and Cyperaceae, and also of unwanted crop plants.

The application rates of the herbicide components in the herbicide combination are, with respect to one another, in the weight ratio stated below:
(range component A):(range component B)
generally (1-100):(0.1-100),
preferably (1-25):(0.5-50),
particularly preferably (1-10):(1-20).

The application rates of the respective herbicide components in the herbicide combination are, per application:
component A: generally 3-3600 g of AS/ha, preferably 5-2000 g of AS/ha, particularly preferably 5-100 g of AS/ha;
component B: generally 1-500 g of AS/ha, preferably 3-300 g of AS/ha, particularly preferably 5-100 g of AS/ha.

Correspondingly, the application rates mentioned above may be used to calculate the percentages by weight (% by weight) of the herbicide components based on the total weight of the herbicidal compositions, which may additionally also comprise other components.

Preference is given to herbicide combinations which, in addition to the combination according to the invention, also comprise one or more further agrochemically active compounds different from herbicides (A) and (B), which also act as a selective herbicide.

The herbicide combination according to the invention may furthermore comprise, as additional further components, various agrochemically active compounds, for example from the group of the safeners, fungicides, insecticides, acaricides, nematicides, biological crop protection agents, bird repellants, soil structure improvers, plant nutrients (fertilizers), and herbicides which differ structurally from herbicides (A) and (B), and plant growth regulators, or from the group of the formulation auxiliaries and additives customary in crop protection.

The herbicide combination according to the invention and the herbicidal compositions obtainable therefrom have excellent herbicidal activity against a broad spectrum of economically important mono- and dicotyledonous harmful plants such as broad-leaved weeds, weed grasses or Cyperaceae, including species resistant to herbicidally active compounds such as glyphosate, glufosinate, atrazine, imidazolinone herbicides, ALS active compounds (e.g. sulfonylureas), (hetero-)aryloxy-aryloxyalkylcarboxylic acids or -phenoxyalkylcarboxylic acids (‘fops’), cyclohexanedionoximes (‘dims’), auxin inhibitors, PS1-(e.g. diquat, paraquat) and HPPD active compounds (e.g. isoxaflutole, tembotrione). The active compounds even have good control over difficult-to-control perennial harmful plants which produce shoots from rhizomes, root stocks or other perennial organs. Here, the substances can be applied, for example, by the pre-sowing method, the pre-emergence method or the post-emergence method, for example jointly or separately. Post-emergence application, for example, is preferred.

Specific examples of some representatives of the monocotyledonous and dicotyledonous weed flora which can be controlled by the compounds of the invention are as follows, though the enumeration is not intended to impose a restriction to particular species. The term “harmful plant” or “weed” may also include crop plants unwanted in the cultivated crop in question (unwanted vegetation).

From among the monocotyledonous weed species, for example, Avena spp., Alopecurus spp., Apera spp., Brachiaria spp., Bromus spp., Digitaria spp., Lolium spp., Echinochloa spp., Eriochloa spp., Leptochloa spp., Fimbristylis spp., Hordeum spp., Panicum spp., Phalaris spp., Poa spp., Pennisetum spp., Eleusine spp., Eragrostis spp., Setaria spp., Triticum spp., Axonopris spp., Melinus spp. Zea spp. and Cyperus species (Cyperus spp.) from the annual group, and from among the perennial species Agropyron spp., Cynodon spp., Carex spp., Imperata spp. and Sorghum spp. and even perennial Cyperus species are controlled well.

Particular examples of monocotyledonous harmful plant species where the herbicide combination according to the invention and compositions according to the present invention can be used effectively are selected from the group consisting of: Hordeum murinum, Echinochloa crus-galli, Poa annua, Bromus rubens L., Bromus rigidus, Bromus secalinus L., Digitaria sanguinalis, Eriochloa gracilis, Setaria faberi, Setaria viridis, Pennisetum glaucum, Eleusine indica, Eragrostis pectinacea, Panicum miliaceum, Lolium multiflorum, Lolium rigidum, Brachiaria platyphylla, Leptochloa fusca, Avena fatua, Carex spp., Cyperus compressus, Cyperus esculentes, Axonopris offinis, Alopecurus myosuroides, Sorghum halapense, Zea mays, Triticum aestivum and Melinus repens.

In the case of dicotyledonous weed species, the activity spectrum extends to species such as Portulaca spp., Richardia spp., Ambrosia spp., Calandrinia spp., Sisymbrium spp., Sesbania spp., Capsella spp., Sonchus spp., Euphorbia spp., Helianthus spp., Coronopus spp., Salsola spp., Abutilon spp., Amaranthus spp., Chenopodium spp., Chrysanthemum spp., Galium spp., Lactuca spp., Malva spp., Ipomoea spp., Kochia spp., Lamium spp., Matricaria spp., Pharbitis spp., Polygonum spp., Urtica spp., Sida spp., Brassica spp., Sinapis spp., Vicia spp., Epilobium spp., Cardamine spp., Picris spp., Trifolium spp., Galinsoga spp., Epimedium spp., Marchantia spp., Solanum spp., Medicago spp., Mollugo spp., Cyclospermum spp., Stellaria spp., Gnaphalium spp., Taraxacum spp., Oenothera spp., Amsinckia spp., Erodium spp., Erigeron spp., Senecio spp., Oxalis spp., Metricaria spp., Plantago spp., Tribulus spp., Cenchrus spp. Bidens spp., Veronica spp., Hypochaeris spp., Eclipta spp., Sesbania spp., Aeschynomene spp., Glycine spp. and Viola spp., Xanthium spp. on the annual side and Convolvulus spp., Cirsium spp., Rumex spp. and Artemisia spp. in the case of perennial weeds.

Particular examples of dicotyledonous harmful plant species where the herbicide combination according to the invention and compositions according to the present invention can be used effectively are selected from the group consisting of: Amaranthus spinosus, Polygonum convolvulus, Medicago polymorpha, Mollugo verticillata, Cyclospermum leptophyllum, Stellaria media, Gnaphalium purpureum, Taraxacum officinale, Oenothera laciniata, Amsinckia intermedia, Erodium cicutarium, Erodium moschatum, Erigeron bonariensis, Senecio vulgaris, Lamium amplexicaule, Erigeron canadensis, Polygonum aviculare, Kochia scoparia, Chenopodium album, Lactuca serriola, Malva parviflora, Malva neglecta, Ipomoea hederacea, Ipomoea lacunose, Brassica nigra, Sinapis arvensis, Urtica dioica, Amaranthus blitoides, Amaranthus retroflexus, Amaranthus hybridus, Amaranthus lividus, Sida spinosa, Portulaca oleracea, Richardia scabra, Ambrosia artemisiifolia, Calandrinia caulescens, Sisymbrium irio, Sesbania exaltata, Capsella bursa-pastoris, Sonchus oleraceus, Euphorbia maculate, Helianthus annuus, Coronopus didymus, Salsola tragus, Abutilon theophrasti, Vicia benghalensis L., Epilobium paniculatum, Cardamine spp, Picris echioides, Trifolium spp., Galinsoga spp., Epimedium spp., Marchantia spp., Solanum spp., Oxalis spp., Metricaria matriccarioides, Plantago spp., Tribulus terrestris, Salsola kali, Cenchrus spp., Viola tricolor, Bidens bipinnata, Glycine max, Veronica spp. and Hypochaeris radicata.

If the active compounds of the herbicide combination according to the invention are applied to the soil surface before germination (with or without incorporation), the seedlings of the harmful plants are either prevented completely from emerging or else the harmful plants grow until they have reached the cotyledon stage, but then their growth stops, and, eventually, after two to four weeks have elapsed, they die completely.

If the active compounds are applied post-emergence to the green parts of the plants, growth likewise stops after the treatment, and the harmful plants remain at the growth stage of the point of time of application, or they die completely after a certain time, so that in this manner competition by the harmful plants, which is harmful to the crop plants, is eliminated very early and in a sustained manner

The herbicide combination according to the invention is distinguished by a rapidly commencing and long-lasting herbicidal action. In general, the rainfastness of the active compounds in the combination according to the invention is favourable. A particular advantage is that the dosages used in the combination and the effective dosages of the active compounds (A) and (B) can be adjusted to such a low level that their soil action is optimal. Therefore, the use thereof in sensitive crops is not just enabled, but groundwater contamination is also virtually prevented. The combination according to the invention of active compounds allows the required application rate of the active compounds to be reduced considerably.

In a preferred embodiment, the herbicide combination according to the invention of the active compounds (A) and (B) is highly suitable for the selective control of harmful plants in permanent crops and on areas of permanent crops (for example fruit plantations and plantation crops, e.g. pome and stone fruit, viticulture, hops, citrus trees, mango, olives, coffee, cacao, tea, soft fruit, banana, cooking banana, almond, walnut, pecan, hazelnut, pistachio trees, oil palms, rubber trees).

In the context of the present invention, the term “permanent crop” refers to the permanent cultivation of plants over several years—in contrast to crops which have to be replanted after every harvest. Permanent crops are cultivated on land for permanent crops in the form of agricultural areas which also include meadows, scrubland or savannas, for example for the cultivation of grapevines or coffee, or in fruit gardens for the cultivation of fruit or olives, or in forest-like plantations used, for example, for nuts or natural rubber.

In the context of the present invention, preferred land for permanent crops are plantations, meadows, scrubland or savannas. In the context of the present invention, the permanent crops are preferably fruit plantations and plantation crops, with preference selected from the group consisting of horticultural or fruit crops (preferably fruit trees, citrus trees, mango trees, olive trees, grapevines, hops bines, coffee, cocoa, tea and soft fruit (such as strawberries, raspberries, blueberries and currants), Musaceae spp. crops (e.g. bananas or plantain crops), nut trees (preferably almond trees, nut trees, pistachio trees, Brasil nut trees, hazelnut trees), oil palms, rubber trees, sugar cane and cotton.

Particularly preferred permanent crops are fruit trees (with preference pome and stone fruit trees, preferred fruit trees are apple trees, pear trees, apricot trees, plum trees, cherry trees, peach trees), olive trees, grapevines, hops bines, coffee, cocoa, tea), Musaceae spp. crops (preferably bananas, cooking bananas or plantain crops), nut trees (preferably almond trees, nut trees, pistachio trees, Brasil nut trees, hazelnut trees), oil palms, rubber trees and citrus fruit (preferably lemon, orange or grapefruit plants). Especially preferred permanent crops are selected from the group consisting of apple trees, pear trees, apricot trees, plum trees, cherry trees, peach trees, mango trees, olive trees, grapevines, hops bines, coffee, cacao, tea, bananas, cooking bananas, nut trees (preferably almond trees, nut trees, pistachio trees), oil palms, rubber trees and citrus fruit (preferably lemon, orange or grapefruit plants). Very particularly preferred permanent crops are selected from the group consisting of apple trees, pear trees, apricot trees, plum trees, cherry trees, peach trees, olive trees, grapevines, hops bines, coffee, cacao, tea, bananas, cooking bananas, almond trees, nut trees, oil palms, rubber trees, citrus fruit, orange fruit and grapefruit crops.

The herbicide combination according to the invention can be employed by any application method known to the person skilled in the art as being suitable for permanent crops and on areas of permanent crops. Preference is given to application methods customary in fruit plantations and plantation crops (for example in pome and stone fruit, viticulture, hops, citrus trees, mango, olives, coffee, cacao, tea, soft fruit, banana, cooking banana, almond, walnut, pecan, hazelnut, pistachio trees, oil palms, rubber trees). This includes, inter alia, the application at different times (split application, splitting), and the application of the herbicides or the herbicide combination in a plurality of portions (sequential application), for example pre-emergence applications followed by post-emergence applications or early post-emergence applications followed by medium or late post-emergence applications. Here, preference is given to the joint or almost simultaneous application of herbicides (A) and (B) of the respective combination, where almost simultaneous means that the herbicides (A) and (B) are applied separately within 24 hours, preferably within 12 hours, more preferably within 6 hours, even more preferably within 3 hours, of one another. In a particularly preferred embodiment, the herbicides (A) and (B) are used together, i.e. at the same time.

The herbicide combination according to the invention covers a broad spectrum of harmful plants which is specific in particular for permanent crops and on areas of permanent crops. From among the monocotyledonous harmful plants, for example, genera such as Avena spp., Alopecurus spp., Apera spp., Brachiaria spp., Bromus spp., Digitaria spp., Lolium spp., Echinochloa spp., Eriochloa spp., Leptochloa spp., Fimbristylis spp., Hordeum spp., Panicum spp., Phalaris spp., Poa spp., Pennisetum spp., Eleusine spp., Eragrostis spp., Setaria spp., Triticum spp., Axonopris spp., Melinus spp. Zea spp. and Cyperus species (Cyperus spp.) from the annual group, and from among the perennial species Agropyron spp., Cynodon spp., Carex spp., Imperata spp. and Sorghum spp. and even perennial Cyperus species are controlled well. In the case of dicotyledonous harmful plants, the activity spectrum extends to genera such as Portulaca spp., Richardia spp., Ambrosia spp., Calandrinia spp., Sisymbrium spp., Sesbania spp., Capsella spp., Sonchus spp., Euphorbia spp., Helianthus spp., Coronopus spp., Salsola spp., Abutilon spp., Amaranthus spp., Chenopodium spp., Chrysanthemum spp., Galium spp., Lactuca spp., Malva spp., Ipomoea spp., Kochia spp., Lamium spp., Matricaria spp., Pharbitis spp., Polygonum spp., Urtica spp., Sida spp., Brassica spp., Sinapis spp., Vicia spp., Epilobium spp., Cardamine spp., Picris spp., Trifolium spp., Galinsoga spp., Epimedium spp., Marchantia spp., Solanum spp., Medicago spp., Mollugo spp., Cyclospermum spp., Stellaria spp., Gnaphalium spp., Taraxacum spp., Oenothera spp., Amsinckia spp., Erodium spp., Erigeron spp., Senecio spp., Oxalis spp., Metricaria spp., Plantago spp., Tribulus spp., Cenchrus spp. Bidens spp., Veronica spp., Hypochaeris spp., Eclipta spp., Sesbania spp., Aeschynomene spp., Glycine spp. and Viola spp., Xanthium spp. on the annual side and Convolvulus spp., Cirsium spp., Rumex spp. and Artemisia spp. in the case of perennial harmful plants.

In a further preferred embodiment, the herbicide combination according to the invention of the active compounds (A) and (B) is also highly suitable for the selective control of harmful plants in rice crops (for example planted or sown under upland or paddy conditions with Indica and/or Japonica species and also hybrids/mutants/GMOs).

The herbicide combination according to the invention can be applied by all application methods customary for rice herbicides. Particularly advantageously, it is applied by spray application and/or by submerged application. In the submerged application, the paddy water covers the soil by up to 3-20 cm even at the time of application. The herbicide combination according to the invention is then applied directly, for example in the form of granules, added to the water of the paddy fields. Worldwide, the spray application is used predominantly with direct seeded rice and the submerged application is used predominantly with transplanted rice.

The herbicide combination according to the invention covers a broad spectrum of harmful plants which is specific in particular for rice crops. From among the monocotyledonous harmful plants, for example, genera such as Echinochloa spp., Panicum spp., Poa spp., Leptochloa spp., Brachiaria spp., Digitaria spp., Setaria spp. Cyperus spp., Monochoria spp., Fimbristylis spp., Sagittaria spp., Eleocharis spp., Scirpus spp., Alisma spp., Aneilema spp., Blyxa spp., Eriocaulon spp., Potamogeton spp. and similar genera are controlled well, in particular the species Echinochloa oryzicola, Monochoria vaginalis, Eleocharis acicularis, Eleocharis kuroguwai, Cyperus difformis, Cyperus serotinus, Sagittaria pygmaea, Alisma canaliculatum, Scirpus juncoides. In the case of the dicotyledonous harmful plants, the activity spectrum extends to genera such as, for example, Polygonum spp., Rorippa spp., Rotala spp., Lindernia spp., Bidens spp., Sphenoclea spp., Dopatrium spp., Eclipta spp., Elatine spp., Gratiola spp., Lindernia spp., Ludwigia spp., Oenanthe spp., Ranunculus spp., Deinostema spp. and the like. In particular species such as Rotala indica, Sphenoclea zeylanica, Lindernia procumbens, Ludwigia prostrate, Potamogeton distinctus, Elatine triandra, Oenanthe javanica are controlled well.

When herbicide (A) and herbicide (B) are applied jointly, there are preferably superadditive (=synergistic) effects. Here, the activity (efficacy) in the combination is higher than the expected sum of the activities of the individual herbicides employed. The synergistic effects allow the application rate to be reduced, a broader spectrum of harmful plants (such as broad-leaved weeds, weed grasses and Cyperaceae) to be controlled, a more rapid onset of the herbicidal action, a longer persistency, a better control of the harmful plants with only one or a few applications and a widening of the application period possible. To some extent, by using the combination, the amount of harmful ingredients, such as nitrogen or oleic acid, and their introduction into the soil are likewise reduced.

The properties and advantages mentioned are necessary in the practical control of harmful plants for keeping agricultural/forestry/horticultural crops or permanent crops and areas of permanent crops or green land/meadows free of unwanted competing plants, and thus to ensure and/or increase yield levels from the qualitative and quantitative angle. This novel herbicide combination markedly exceeds the technical state of the art with a view to the properties described.

Although the compositions comprising the herbicide combination according to the invention have excellent activity toward mono- and dicotyledonous harmful plants, the crop plants to be protected are damaged only to a minor degree, if at all.

Owing to their improved application profile, these compositions according to the invention can also be employed for controlling harmful plants in known plant crops or in tolerant or genetically modified crop and energy plants still to be developed. In general, transgenic plants (GMOs) are characterized by particular advantageous properties, for example by resistances to certain pesticides, in particular certain herbicides (such as resistances against components A and B in the compositions according to the invention), for example by resistances to harmful insects, plant diseases or pathogens of plant diseases, such as certain microorganisms such as fungi, bacteria or viruses. Other specific characteristics relate, for example, to the harvested material with regard to quantity, quality, storability, and the composition of specific constituents. Thus, transgenic plants are known whose starch content is increased, or whose starch quality is altered, or those where the harvested material has a different fatty acid composition, or increased vitamin content or energetic properties. Further special properties may be tolerance or resistance to abiotic stressors, for example heat, cold, drought, salinity and ultraviolet radiation. In the same manner, owing to their herbicidal and other properties, the compositions according to the invention can also be used for controlling harmful plants in crops of known plants or plants still to be developed by mutant selection, and also crossbreeds of mutagenic and transgenic plants.

Conventional ways of producing novel plants which have modified properties in comparison to existing plants consist, for example, in traditional cultivation methods and the generation of mutants. Alternatively, novel plants with altered properties can be generated with the aid of recombinant methods (see, for example, EP 0221044 A, EP 0131624 A). For example, in several cases the following have been described: genetic modifications of crop plants for the purpose of modifying the starch synthesized in the plants (for example WO 92/011376 A, WO 92/014827 A, WO 91/019806 A); transgenic crop plants which are resistant to certain herbicides of the glufosinate type (cf., for example, EP 0242236 A, EP 0242246 A) or glyphosate (WO 92/000377 A) or of the sulfonylurea type (EP 0257993 A, U.S. Pat. No. 5,013,659) or to combinations or mixtures of these herbicides through “gene stacking”, such as transgenic crop plants e.g. corn or soybean with the tradename or the name Optimum™ GAT™ (glyphosate ALS tolerant); transgenic crop plants, for example cotton, with the capability of producing Bacillus thuringiensis toxins (Bt toxins) which make the plants resistant to certain pests (EP 0142924 A, EP 0193259 A); transgenic crop plants having a modified fatty acid composition (WO 91/013972 A); genetically modified crop plants having novel constituents or secondary compounds, for example novel phytoalexins providing increased resistance to disease (EP 0309862 A, EP 0464461 A); genetically modified plants having reduced photorespiration, which provide higher yields and have higher stress tolerance (EP 0305398 A); transgenic crop plants producing pharmaceutically or diagnostically important proteins (“molecular pharming”); transgenic crop plants distinguished by higher yields or better quality; transgenic crop plants distinguished by a combination, for example of the novel properties mentioned above (“gene stacking”).

Numerous molecular biology techniques which can be used to produce novel transgenic plants with modified properties are known in principle; see, for example, I. Potrykus and G. Spangenberg (eds.), Gene Transfer to Plants, Springer Lab Manual (1995), Springer Verlag Berlin, Heidelberg or Christou, “Trends in Plant Science” 1 (1996) 423-431). For such recombinant manipulations, nucleic acid molecules which allow mutagenesis or sequence alteration by recombination of DNA sequences can be introduced into plasmids. With the aid of standard methods, it is possible, for example, to undertake base exchanges, remove parts of sequences or add natural or synthetic sequences. To join the DNA fragments with one another, adapters or linkers can be placed onto the fragments, see, for example, Sambrook et al., 1989, Molecular Cloning, A Laboratory Manual, 2nd edition Cold Spring Harbor Laboratory Press, Cold Spring Harbor, N.Y., or Winnacker “Gene and Klone [Genes and clones]”, VCH Weinheim 2nd edition 1996.

For example, the generation of plant cells with a reduced activity of a gene product can be achieved by expressing at least one corresponding antisense RNA, a sense RNA for achieving a cosuppression effect, or by expressing at least one suitably constructed ribozyme which specifically cleaves transcripts of the abovementioned gene product.

To this end, it is firstly possible to use DNA molecules which encompass the entire coding sequence of a gene product inclusive of any flanking sequences which may be present, and also DNA molecules which only encompass portions of the coding sequence, in which case it is necessary for these portions to be long enough to have an antisense effect in the cells. It is also possible to use DNA sequences which have a high degree of homology to the coding sequences of a gene product, but are not completely identical.

When expressing nucleic acid molecules in plants, the protein synthesized may be localized in any desired compartment of the plant cell. However, to achieve localization in a particular compartment, it is possible, for example, to join the coding region to DNA sequences which ensure localization in a particular compartment. Such sequences are known to those skilled in the art (see, for example, Braun et al., EMBO J. 11 (1992), 3219-3227; Wolter et al., Proc. Natl. Acad. Sci. USA 85 (1988), 846-850; Sonnewald et al., Plant J. 1 (1991), 95-106). The nucleic acid molecules can also be expressed in the organelles of the plant cells.

The transgenic plant cells can be regenerated by known techniques to give rise to entire plants. In principle, the transgenic plants may be plants of any desired plant species, i.e. not only monocotyledonous but also dicotyledonous plants. Thus, transgenic plants can be obtained whose properties are altered by overexpression, suppression or inhibition of homologous (=natural) genes or gene sequences or expression of heterologous (=foreign) genes or gene sequences.

The present invention also provides a method for controlling unwanted vegetation (e.g. harmful plants); preferably in crop plants such as cereals (e.g. durum and bread wheat, barley, rye, oats, crossbreeds thereof such as triticale, planted or sown rice under upland or paddy conditions, maize, millet such as, for example, sorghum), sugar beet, sugar cane, oilseed rape, cotton, sunflowers, soya bean, potato, tomato, beans such as, for example, bush bean and broad bean, flax, pasture grass, permanent crops and on areas of permanent crops (fruit plantations and plantation crops, for example pome and stone fruit, viticulture, hops, citrus trees, mango, olives, coffee, cacao, tea, soft fruit, banana, cooking banana, almond, walnut, pecan, hazelnut, pistachio trees, oil palms, rubber trees), greens and lawns and squares of residential areas or industrial sites, railway installations; particularly preferably in monocotyledonous crops such as cereals, e.g. wheat, barley, rye, oats, crossbreeds thereof such as triticale, rice (planted or sown under upland or paddy conditions with Indica and/or Japonica species and also hybrids/mutants/GMOs), maize, millet and sugar cane, and also dicotyledonous crops such as sugar beet, sunflowers, soya bean, potato, tomatoes, peas, beans (such as, for example, bush bean and broad bean), carrots and fennel; and in permanent crops and on areas of permanent crops (fruit plantations and plantation crops, for example pome and stone fruit, viticulture, hops, citrus trees, mango, olives, coffee, cacao, tea, soft fruit, banana, cooking banana, almond, walnut, pecan, hazelnut, pistachio trees, oil palms, rubber trees); in particular in permanent crops and on areas of permanent crops and also in rice crops; where the components A and B of the herbicide combination are applied jointly or separately, for example by the pre-emergence method (very early to late), post-emergence method or by the pre- and post-emergence method, to the harmful plants (and, for example, their plant parts), their seed (e.g. plant seeds) or vegetative propargation organs, or the area on which these plants grow (e.g. their cultivation area).

The invention also provides the use of the herbicidal compositions according to the invention comprising the components A and B for controlling harmful plants, preferably in crop plants, preferably in the crop plants mentioned above. The invention also provides the use of the herbicidal compositions according to the invention comprising the components A and B for controlling herbicide-resistant harmful plants (for example TSR and EMR resistances in the case of ALS and ACCase), preferably in crop plants, preferably in the crop plants mentioned above.

The invention also provides the method with the herbicidal compositions according to the invention comprising the components A and B for the selective control of harmful plants in crop plants, preferably in the crop plants mentioned above, and its use.

The invention also provides the method for controlling unwanted vegetation with the herbicidal compositions according to the invention comprising the components A and B, and its use in crop plants which have been modified by genetic engineering (transgenic) or obtained by mutation selection (for example tolerance by selective breeding), and which are resistant to growth regulators such as, for example, 2,4 D, dicamba, or against herbicides which inhibit essential plant enzymes, for example acetolactate synthases (ALS), EPSP synthases, glutamine synthases (GS) or hydroxyphenylpyruvate dioxygenases (HPPD), or respectively to herbicides from the group of the sulfonylureas, glyphosates, glufosinates or benzoylisoxazoles and analogous active compounds, or to any combinations of these active compounds. The herbicidal compositions according to the invention can be used with particular preference in transgenic crop plants which are resistant to a combination of glyphosates and glufosinates, glyphosates and sulfonylureas or imidazolinones. Very particularly preferably, the herbicidal compositions according to the invention can be used in transgenic crop plants such as, for example, corn or soybean with the tradename or the name Optimum™ GAT™ (glyphosate ALS tolerant).

The herbicidal compositions according to the invention can also be employed non-selectively for controlling unwanted vegetation, for example in permanent crops and on areas of permanent crops (fruit plantations and plantation crops, for example pome and stone fruit, viticulture, hops, citrus trees, mango, olives, coffee, cacao, tea, soft fruit, banana, cooking banana, almond, walnut, pecan, hazelnut, pistachio trees, oil palms, rubber trees), at the wayside, on squares, industrial sites or railway installations, or are employed selectively for the control of unwanted vegetation in crops for energy generation (e.g. biogas, bioethanol, biodiesel).

The herbicidal compositions according to the invention can be present both as mixed formulations of components A and B and, if appropriate, with further agrochemical active compounds, additives and/or customary formulation auxiliaries which are then applied in a customary manner diluted with water, or can be prepared as so-called tank mixes by joint dilution of the separately formulated or partially separately formulated components with water. In certain cases, the mixed formulations can be diluted with other liquids or solids, or else be applied in undiluted form.

The components A and B can be formulated in various ways according to which biological and/or physicochemical parameters are required. Examples of general formulation options are: wettable powders (WP), water-soluble concentrates, emulsifiable concentrates (EC), aqueous solutions (SL), emulsions (EW), such as oil-in-water and water-in-oil emulsions, sprayable solutions or emulsions, suspension concentrates (SC), dispersions, oil dispersions (OD), suspoemulsions (SE), dusts (DP), seed-dressing products, granules for soil application or spreading (GR) or water-dispersible granules (WG), ultra-low volume formulations, microcapsule dispersions or wax dispersions. Mention may also be made of foams, pastes, granules, aerosols, active compound-impregnated natural and synthetic substances, microencapsulations in polymeric substances. The formulations may comprise the customary auxiliaries and additives.

The individual types of formulation are known in principle and are described, for example, in: “Manual on Development and Use of FAO and WHO Specifications for Pesticides”, FAO and WHO, Rome, Italy, 2002; Winnacker-Küchler, “Chemische Technologic” [Chemical Engineering], Volume 7, C. Hanser Verlag Munich, 4th Ed. 1986; van Valkenburg, “Pesticide Formulations”, Marcel Dekker N.Y. 1973; K. Martens, “Spray Drying Handbook”, 3rd Ed. 1979, G. Goodwin Ltd. London.

The formulation auxiliaries required, such as inert materials, surfactants, solvents and further additives, are likewise known and are described, for example, in: Watkins, “Handbook of Insecticide Dust Diluents and Carriers”, 2nd Ed., Darland Books, Caldwell N.J.; H.v. Olphen, “Introduction to Clay Colloid Chemistry”; 2nd Ed., J. Wiley & Sons, N.Y.; Marsden, “Solvents Guide”, 2nd Ed., Interscience, N.Y. 1950; McCutcheon's “Detergents and Emulsifiers Annual”, MC Publ. Corp., Ridgewood N.J.; Sisley and Wood, “Encyclopedia of Surface Active Agents”, Chem. Publ. Co. Inc., N.Y. 1964; Schönfeldt, “Grenzflächenaktive Äthylenoxidaddukte [Interface-active ethylene oxide adducts]”, Wiss. Verlagsgesellschaft, Stuttgart 1976, Winnacker Küchler, “Chemische Technologic [Chemical Engineering]”, Volume 7, C. Hanser Verlag Munich, 4th Ed. 1986. Hereinbelow, by way of example, formulations with further more specific formulation auxiliaries are mentioned which can also be used in other formulations.

Wettable powders (sprayable powders) are products which are uniformly dispersible in water and which, besides the active compounds and in addition to one or more diluents or inert substances, also comprise ionic and/or nonionic surfactants (wetting agents, dispersants), for example polyoxyethylated alkylphenols, polyethoxylated fatty alcohols or fatty amines, propylene oxide/ethylene oxide copolymers, alkanesulfonates or alkylbenzenesulfonates or alkylnaphthalenesulfonates, sodium lignosulfonate, sodium 2,2′-dinaphthylmethane-6,6′-disulfonate, sodium dibutylnaphthalenesulfonate or else sodium oleoylmethyltaurate.

Emulsifiable concentrates are prepared by dissolving the active compounds in an organic solvent or solvent mixture, for example butanol, cyclohexanone, dimethylformamide, acetophenone, xylene or else higher-boiling aromatics or hydrocarbons with addition of one or more ionic and/or nonionic surfactants (emulsifiers). Examples of emulsifiers which may be used are: calcium alkylarylsulfonates such as calcium dodecylbenzenesulfonate, or nonionic emulsifiers such as fatty acid polyglycol esters, alkylaryl polyglycol ethers, fatty alcohol poly glycol ethers, propylene oxide-ethylene oxide copolymers, alkyl polyethers, sorbitan fatty acid esters, polyoxyethylene sorbitan fatty acid esters or polyoxyethylene sorbitol esters.

Dusting products are obtained by grinding the active compound with finely distributed solids, for example talc, natural clays, such as kaolin, bentonite and pyrophyllite, or diatomaceous earth.

Suspension concentrates are water-based suspensions of active compounds. They may be prepared, for example, by wet grinding by means of commercially available bead mills and optional addition of further surfactants as have, for example, already been listed above for the other formulation types. In addition to the suspended active compound or active compounds, other active compounds may also be present in the formulation in dissolved form.

Oil dispersions are oil-based suspensions of active compounds, where oil is to be understood as meaning any organic liquid, for example vegetable oils, aromatic or aliphatic solvents, or fatty acid alkyl esters. They can be prepared, for example, by wet grinding by means of commercially available bead mills and, if appropriate, addition of further surfactants (wetting agents, dispersants) as have already been mentioned, for example, above in the case of the other formulation types. In addition to the suspended active compound or active compounds, other active compounds may also be present in the formulation in dissolved form.

Emulsions, for example oil-in-water emulsions (EW), can be prepared, for example, by means of stirrers, colloid mills and/or static mixers from mixtures of water and water-immiscible organic solvents and, if appropriate, further surfactants as have already been mentioned, for example, above in the case of the other formulation types. Here, the active compounds are present in dissolved form.

Granules can be prepared either by spraying the active compound onto adsorptive, granulated inert material or by applying active compound concentrates to the surface of carriers such as sand, kaolinites, chalk or granulated inert material with the aid of adhesives, for example polyvinyl alcohol, sodium polyacrylate or else mineral oils. Suitable active compounds can also be granulated in the manner customary for the production of fertilizer granules—if desired as a mixture with fertilizers. Water-dispersible granules are produced generally by the customary processes such as spray-drying, fluidized-bed granulation, pan granulation, mixing with high-speed mixers and extrusion without solid inert material. For the production of pan, fluidized-bed, extruder and spray granules, see e.g. processes in “Spray-Drying Handbook” 3rd Ed. 1979, G. Goodwin Ltd., London; J. E. Browning, “Agglomeration”, Chemical and Engineering 1967, pages 147 ff; “Perry's Chemical Engineer's Handbook”, 5th Ed., McGraw Hill, New York 1973, p. 8-57.

For further details regarding the formulation of crop protection compositions, see, for example, G. C. Klingman, “Weed Control as a Science”, John Wiley and Sons, Inc., New York, 1961, pages 81-96 and J. D. Freyer, S. A. Evans, “Weed Control Handbook”, 5th Ed., Blackwell Scientific Publications, Oxford, 1968, pages 101-103.

Based on these formulations, it is also possible to prepare combinations with other agrochemical active compounds (according to the list above), for example in the form of a readymix (coformulation) or as tank mix.

The agrochemical formulations generally comprise from 0.1 to 95 percent by weight (% by weight), preferably from 0.5 to 90% by weight, of active compounds of the herbicide components, the following concentrations being customary, depending on the type of formulation: in wettable powders, the active compound concentration is, for example, about 10 to 95% by weight, the remainder to 100% by weight consisting of customary formulation constituents. In the case of emulsifiable concentrates, the active compound concentration can be, for example, from 5 to 80% by weight. In most cases, formulations in the form of dusts comprise from 5 to 20% by weight of active compound, sprayable solutions comprise about 0.2 to 25% by weight of active compound. In the case of granules such as dispersible granules, the active compound content depends partially on whether the active compound is present in liquid or solid form and on which granulation auxiliaries and fillers are used. In water-dispersible granules, the content is generally between 10 and 90% by weight.

In addition, the active compound formulations mentioned optionally comprise the respective customary adhesives, wetting agents, dispersants, emulsifiers, preservatives, antifreeze agents and solvents, fillers, colorants and carriers, antifoams, evaporation inhibitors and pH- or viscosity-modifying agents.

The herbicidal action of the herbicide combinations according to the invention can be improved, for example, by surfactants, for example by wetting agents from the group of the fatty alcohol polyglycol ethers. The fatty alcohol polyglycol ethers preferably comprise 10-18 carbon atoms in the fatty alcohol radical and 2-20 ethylene oxide units in the poly glycol ether moiety. The fatty alcohol polyglycol ethers may be present in nonionic form, or ionic form, for example in the form of fatty alcohol polyglycol ether sulfates or phosphates, which are used, for example, as alkali metal salts (for example sodium salts and potassium salts) or ammonium salts, or even as alkaline earth metal salts, such as magnesium salts, such as C₁₂/C₁₄-fatty alcohol diglycol ether sulfate sodium (Genapol® LRO, Clariant GmbH); see, for example, EP-A-0476555, EP-A-0048436, EP-A-0336151 or U.S. Pat. No. 4,400,196 and also Proc. EWRS Symp. “Factors Affecting Herbicidal Activity and Selectivity”, 227-232 (1988). Nonionic fatty alcohol polyglycol ethers are, for example, (C₁₀-C₁₈)-, preferably (C₁₀-₁₄)-fatty alcohol polyglycol ethers (for example isotridecyl alcohol polyglycol ethers) which comprise 2-20, preferably 3-15, ethylene oxide units, for example from the Genapol® X series, such as Genapol® X-030, Genapol® X-060, Genapol® X-080 or Genapol® X-150 (all from Clariant GmbH).

The present invention further comprises the combination of components A and B with the wetting agents mentioned above from the group of the fatty alcohol polyglycol ethers which preferably contain 10-18 carbon atoms in the fatty alcohol radical and 2-20 ethylene oxide units in the poly glycol ether moiety and which may be present in nonionic or ionic form (for example as fatty alcohol polyglycol ether sulfates). Preference is given to sodium C₁₂/C₁₄-fatty alcohol diglycol ether sulfate (Genapol® LRO, Clariant GmbH) and isotridecyl alcohol polyglycol ethers having 3-15 ethylene oxide units, for example from the Genapol® X series, such as Genapol® X-030, Genapol® X-060, Genapol® X-080 and Genapol® X-150 (all from Clariant GmbH). It is also known that fatty alcohol polyglycol ethers, such as nonionic or ionic fatty alcohol polyglycol ethers (for example fatty alcohol polyglycol ether sulfates) are also suitable as penetrants and activity enhancers for a number of other herbicides, including herbicides from the group of the imidazolinones (see, for example, EP-A-0502014).

The herbicidal action of the herbicide combinations according to the invention can also be enhanced by using vegetable oils. The term vegetable oils is to be understood as meaning oils of oleaginous plant species, such as soybean oil, rapeseed oil, corn oil, sunflower oil, cottonseed oil, linseed oil, coconut oil, palm oil, thistle oil or castor oil, in particular rapeseed oil, and also their transesterification products, for example alkyl esters, such as rapeseed oil methyl ester or rapeseed oil ethyl ester.

The vegetable oils are preferably esters of C₁₀-C₂₂-, preferably C₁₂-C₂₀-, fatty acids. The C₁₀-C₂₂-fatty acid esters are, for example, esters of unsaturated or saturated C₁₀-C₂₂-fatty acids having, in particular, an even number of carbon atoms, for example erucic acid, lauric acid, palmitic acid and in particular C₁₈-fatty acids such as stearic acid, oleic acid, linoleic acid or linolenic acid.

Examples of C₁₀-C₂₂-fatty acid esters are esters which are obtained by reacting glycerol or glycol with the C₁₀-C₂₂-fatty acids present, for example, in oils of oleaginous plant species, or C₁₀-C₂₂-fatty acid C₁-C₂₀-alkyl esters which can be obtained, for example, by transesterification of the glycerol or glycol C₁₀-C₂₂-fatty acid esters mentioned above with C₁-C₂₀-alcohols (for example methanol, ethanol, propanol or butanol). The transesterification can be carried out by known methods as described, for example, in Römpp Chemie Lexikon, 9th edition, Volume 2, page 1343, Thieme Verlag Stuttgart.

Preferred C₁₀-C₂₂-fatty acid C₁-C₂₀-alkyl esters are methyl esters, ethyl esters, propyl esters, butyl esters, 2-ethylhexyl esters and dodecyl esters. Preferred glycol and glycerol C₁₀-C₂₂-fatty acid esters are the uniform or mixed glycol esters and glycerol esters of C₁₀-C₂₂-fatty acids, in particular fatty acids having an even number of carbon atoms, for example erucic acid, lauric acid, palmitic acid and in particular C₁₈-fatty acids such as stearic acid, oleic acid, linoleic acid or linolenic acid.

In the herbicidal compositions according to the invention, the vegetable oils can be present, for example, in the form of commercially available oil-containing formulation additives, in particular those based on rapeseed oil, such as Hasten® (Victorian Chemical Company, Australia, hereinbelow referred to as Hasten, main ingredient: rapeseed oil ethyl ester), Actirob® B (Novance, France, hereinbelow referred to as ActirobB, main ingredient: rapeseed oil methyl ester), Rako-Binol® (Bayer AG, Germany, hereinbelow referred to as Rako-Binol, main ingredient: rapeseed oil), Renol® (Stefes, Germany, hereinbelow referred to as Renol, vegetable oil ingredient: rapeseed oil methyl ester) or Stefes Mero® (Stefes, Germany, hereinbelow referred to as Mero, main ingredient: rapeseed oil methyl ester).

In a further embodiment, the present invention embraces combinations of the components A and B with the vegetable oils mentioned above, such as rapeseed oil, preferably in the form of commercially available oil-containing formulation additives, in particular those based on rapeseed oil, such as Hasten®, Actirob® B, Rako-Binol®, Renol® or Stefes Mero®.

For application, the formulations in commercial form are, if appropriate, diluted in a customary manner, for example in the case of wettable powders, emulsifiable concentrates, dispersions and water-dispersible granules with water. Dust-type preparations, granules for soil application or granules for scattering and sprayable formulations are not normally diluted further with other inert substances prior to application.

The active compounds can be applied to the plants (for example harmful plants, such as monocotyledonous or dicotyledonous broad-leaved weeds, weed grasses, Cyperaceae or unwanted crop plants), the seed (for example grains, seeds or vegetative propagation organs, such as tubers or shoot parts with buds) or the area under cultivation (for example the soil), preferably to the green plants and parts of plants and, if appropriate, additionally the soil. Application is accomplished in a customary manner, for example by watering, spraying, atomizing or broadcasting.

One possible use is the joint application of the active compounds in the form of tank mixes, where the optimally formulated concentrated formulations of the individual active compounds are, together, mixed in a tank with water, and the spray liquor obtained is applied. A joint herbicidal formulation (coformulation) of the herbicidal compositions according to the invention comprising the components A and B has the advantage that it can be applied more easily since the quantities of the components are already adjusted to the correct ratio to one another. Moreover, the auxiliaries in the formulation can be optimized to one another.

### A. GENERAL FORMULATION EXAMPLES

a) A dust is obtained by mixing 10 parts by weight of an active compound/active compound mixture and 90 parts by weight of talc as inert substance and comminuting the mixture in a hammer mill.
b) A wettable powder which is readily dispersible in water is obtained by mixing 25 parts by weight of an active compound/active compound mixture, 64 parts by weight of kaolin-containing clay as inert substance, 10 parts by weight of potassium lignosulfonate and 1 part by weight of sodium oleoylmethyltaurate as wetting agent and dispersant, and grinding the mixture in a pinned-disc mill.
c) A suspension concentrate which is readily dispersible in water is obtained by mixing 20 parts by weight of an active compound/active compound mixture with 5 parts by weight of tristyrylphenol polyglycol ether (Soprophor BSU), 1 part by weight of sodium lignosulfonate (Vanisperse CB) and 74 parts by weight of water, and grinding the mixture in a friction ball mill to a fineness of below 5 microns.
d) An oil dispersion which is readily dispersible in water is obtained by mixing 20 parts by weight of an active compound/active compound mixture with 6 parts by weight of alkylphenol polyglycol ether (Triton® X 207), 3 parts by weight of isotridecanol polyglycol ether (8 EO) and 71 parts by weight of paraffinic mineral oil (boiling range for example approx. 255 to 277° C.), and grinding the mixture in a friction ball mill to a fineness of below 5 microns.
e) An emulsifiable concentrate is obtained from 15 parts by weight of an active compound/active compound mixture, 75 parts by weight of cyclohexanone as solvent and 10 parts by weight of oxyethylated nonylphenol as emulsifier.
f) Water-dispersible granules are obtained by mixing
75 parts by weight of an active compound/active compound mixture,
10 parts by weight of calcium lignosulfonate,
5 parts by weight of sodium lauryl sulfate,
3 parts by weight of polyvinyl alcohol and
7 parts by weight of kaolin,
   grinding the mixture in a pinned-disc mill, and granulating the powder in a fluidized bed by spray application of water as a granulating liquid.
   g) Water-dispersible granules are also obtained by homogenizing and precomminuting, in a colloid mill,
25 parts by weight of an active compound/active compound mixture,
5 parts by weight of sodium 2,2′-dinaphthylmethane-6,6′-disulfonate
2 parts by weight of sodium oleoylmethyltaurate,
1 part by weight of polyvinyl alcohol
17 parts by weight of calcium carbonate and
50 parts by weight of water,
   then grinding the mixture in a bead mill and atomizing and drying the resulting suspension in a spray tower by means of a one-phase nozzle.

### B. BIOLOGICAL EXAMPLES

### Greenhouse Trials

a) Method

Post-emergence action against weeds

Seeds or rhizome pieces of mono- and dicotyledonous harmful plants and of crop plants were placed in sandy loam in plastic pots having a diameter of 4 cm, covered with soil and cultivated in a greenhouse under good growth conditions.

Ten to twenty days after sowing, the test plants were treated at the one- to three-leaf stage. The herbicide/active compound combinations according to the invention (mixture applications) formulated as suspensions and, in parallel tests, the correspondingly formulated individual active compounds (individual applications) were then sprayed onto the green parts of the plants in various dosages at a water application rate of 300 I/ha (converted).

After the test plants had been kept in the greenhouse under optimum growth conditions for a certain period of time (DAA, days after application), the herbicidal activity was assessed visually by comparison of treated and untreated plants. The percentages mean: 0%=no herbicidal activity, 100%=the plants die off completely.

The percentages from the treatments with the herbicides alone (individual applications) and with the combinations according to the invention (mixture applications) were employed to calculate interactions using the method of Colby. When the observed efficacies of the mixture applications exceed the formal sum of the values of the tests with individual applications, they also exceed the expected value according to Colby, which is calculated using the formula below (cf. S. R. Colby; in Weeds 15 (1967) pp. 20 to 22):

E=A+B−(A×B/ 100)

Here:
A, B=activity of component A (triafamone) or B (indaziflam) in percent at a dosage of a and b, respectively, in g of AS/ha (gram of active substance per hectare).
exp. expected value in % at a dosage of a+b g of ai/ha.
   b) Results

The abbreviations in the tables below have the following meanings:
DAA=days after application
g of AS/ha=grams of active substance per hectare
% efficacy=herbicidal effect in percent
meas.=measured values
exp.=expected values according to Colby (calculation: see above)
syn.%=difference (%) of measured value from expected value (%) (measured value minus expected value)/

TABLE 1
Herbicidal effect (% efficacy) against Triticum aestivum (9 DAA)

| | | | % | | |
|---|---|---|---|---|---|
| | (g of AS/ha) | | Efficacy | | |
| triafamone | 20 | | 13 | | |
| | 10 | | 0 | | |
| | 5 | | 0 | | |
| | 2.5 | | 0 | | |
| indaziflam | 40 | | 63 | | |
| | 20 | | 48 | | |
| | 10 | | 23 | | |
| | 5 | | 23 | | |
| | | | meas. | exp. | syn. % |
| triafamone + | 20 | +40 | 78 | 67 | 10 |
| indaziflam | 10 | +20 | 60 | 48 | 13 |
| | 10 | +10 | 50 | 23 | 28 |
| | 5 | +40 | 83 | 63 | 20 |
| | 5 | +20 | 78 | 48 | 30 |
| | 2.5 | +40 | 75 | 63 | 13 |
| | 2.5 | +10 | 58 | 23 | 35 |
| | 2.5 | +5 | 45 | 23 | 23 |

TABLE 2
Herbicidal effect (% efficacy) against Lolium rigidum (9 DAA)

| | | | % | | |
|---|---|---|---|---|---|
| | (g of AS/ha) | | Efficacy | | |
| triafamone | 20 | | 18 | | |
| | 10 | | 0 | | |
| | 5 | | 0 | | |
| | 2.5 | | 0 | | |
| indaziflam | 20 | | 70 | | |
| | 10 | | 63 | | |
| | | | meas. | exp. | syn. % |
| triafamone + | 20 | +20 | 85 | 75 | 10 |
| indaziflam | 10 | +20 | 83 | 70 | 13 |
| | 5 | +20 | 85 | 70 | 15 |
| | 5 | +10 | 75 | 63 | 13 |
| | 2.5 | +20 | 83 | 70 | 13 |

TABLE 3
Herbicidal effect (% efficacy) against Alopecurus myosuroides
(17 DAA)

| | | | % | | |
|---|---|---|---|---|---|
| | (g of AS/ha) | | Efficacy | | |
| triafamone | 5 | | 50 | | |
| | 2.5 | | 25 | | |
| indaziflam | 20 | | 75 | | |
| | 10 | | 60 | | |
| | 5 | | 15 | | |
| | | | meas. | exp. | syn. % |
| triafamone + | 5 | +20 | 99 | 87 | 12 |
| indaziflam | 5 | +5 | 85 | 57 | 28 |
| | 2.5 | +10 | 80 | 70 | 10 |
| | 2.5 | +5 | 62 | 36 | 26 |

TABLE 4
Herbicidal effect (% efficacy) against Viola tricolor (17 DAA)

| | | | % | | |
|---|---|---|---|---|---|
| | (g of AS/ha) | | Efficacy | | |
| triafamone | 10 | | 0 | | |
| | 5 | | 0 | | |
| | 2.5 | | 0 | | |
| indaziflam | 5 | | 80 | | |
| | | | meas. | exp. | syn. % |
| triafamone + | 10 | +5 | 90 | 80 | 10 |
| indaziflam | 5 | +5 | 90 | 80 | 10 |
| | 2.5 | +5 | 97 | 80 | 16.5 |

TABLE 5
Herbicidal effect (% efficacy) against Zea mays (17 DAA)

| | | | % | | |
|---|---|---|---|---|---|
| | (g of AS/ha) | | Efficacy | | |
| triafamone | 10 | | 0 | | |
| | 5 | | 0 | | |
| | 2.5 | | 0 | | |
| indaziflam | 20 | | 25 | | |
| | 10 | | 0 | | |
| | | | meas. | exp. | syn. % |
| triafamone + | 10 | +20 | 70 | 25 | 45 |
| indaziflam | 5 | +20 | 45 | 25 | 20 |
| | 5 | +10 | 10 | 0 | 10 |
| | 2.5 | +10 | 10 | 0 | 10 |

TABLE 6
Herbicidal effect (% efficacy) against Avena fatua (17 DAA)

| | | | % | | |
|---|---|---|---|---|---|
| | (g of AS/ha) | | Efficacy | | |
| triafamone | 10 | | 0 | | |
| indaziflam | 5 | | 10 | | |
| | | | meas. | exp. | syn. % |
| triafamone + | 10 | +5 | 28 | 10 | 18 |
| indaziflam | | | | | |

TABLE 7
Herbicidal effect (% efficacy) against Hordeum murinum (17 DAA)

| | | | % | | |
|---|---|---|---|---|---|
| | (g of AS/ha) | | Efficacy | | |
| triafamone | 20 | | 0 | | |
| | 5 | | 0 | | |
| | 2.5 | | 0 | | |
| indaziflam | 20 | | 40 | | |
| | | | meas. | exp. | syn. % |
| triafamone + | 20 | +20 | 97 | 40 | 56.5 |
| indaziflam | 5 | +20 | 75 | 40 | 35 |
| | 2.5 | +20 | 78 | 40 | 37.5 |

TABLE 8
Herbicidal effect (% efficacy) against Glycine max (17 DAA)

| | | | % | | |
|---|---|---|---|---|---|
| | (g of AS/ha) | | Efficacy | | |
| triafamone | 10 | | 0 | | |
| | 2.5 | | 0 | | |
| indaziflam | 10 | | 73 | | |
| | 5 | | 50 | | |
| | | | meas. | exp. | syn. % |
| triafamone + | 10 | +10 | 83 | 73 | 10 |
| indaziflam | 10 | +5 | 60 | 50 | 10 |
| | 2.5 | +10 | 83 | 73 | 10 |
| | 2.5 | +5 | 65 | 50 | 15 |

c) Discussion of the results

The results show an unexpected synergism of the herbicide combination according to the invention, where in some cases the difference of the measured values to the corresponding expected values (syn.%) is quite considerable. It is noteworthy that the herbicidal efficacy of indaziflam (component B) was generally enhanced by triafamone (component A), which, at the dosages tested, was frequently ineffective as individual herbicide.

1. A herbicide combination, comprising components (A) and (B), where
(A) comprises a compound and/or a salt thereof of formula (A): 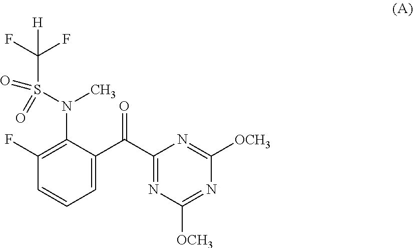 [SMILES: COc1nc(OC)nc(C(=O)c2cccc(F)c2N(C)S(=O)(=O)C(F)F)n1]
and
(B) comprises a compound and/or a stereoisomer thereof of formula (B):

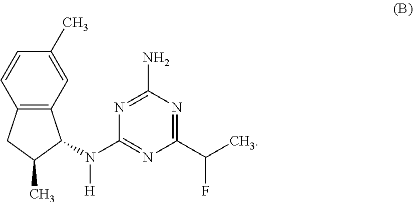 [SMILES: Cc1ccc2c(c1)[C@H](Nc1nc(N)nc(C(C)F)n1)[C@@H](C)C2]

2. The herbicide combination according to claim 1, wherein the herbicide components, with respect to one another, are present in a weight ratio of:
(range component A):(range component B)
(1-100):(0.1-100),
optionally (1-25):(0.5-50),
optionally (1-10):(1-20).

3. The herbicide combination according to claim 1, comprising the herbicide components in an application rate per application:
component A: 3-3600 g of AS/ha, optionally 5-2000 g of AS/ha, optionally 5-100 g of AS/ha;
component B: generally 1-500 g of AS/ha, optionally 3-300 g of AS/ha, optionally 5-100 g of AS/ha.

4. The herbicide combination according to claim 1, comprising an effective amount of components (A) and (B) and/or additionally one or more further components selected from the group consisting of agrochemically active compounds of a different type, formulation auxiliaries and additives customary in crop protection.

5. A method for control of unwanted vegetation which comprises applying the components (A) and (B) of the herbicide combination, as defined in claim 1, jointly or separately to one or more harmful plants, seed or vegetative propagation organs thereof, and/or to an area where said plants grow.

6. The process according to claim 5 for controlling unwanted vegetation in monocotyledonous crops optionally comprising cereal, optionally wheat, barley, rye, oats, crossbreeds thereof optionally triticale, rice (planted or sown under upland or paddy conditions with Indica and/or Japonica species and also hybrids/mutants/GMOs), maize, millet and sugar cane, and/or in dicotyledonous crops optionally comprising sugar beet, sunflowers, soya bean, potato, tomatoes, peas, beans optionally, bush bean and broad bean), carrots and fennel; and/or in permanent crops and/or on one or more areas of permanent crops (fruit plantations and plantation crops, optionally pome and stone fruit, viticulture, hops, citrus trees, mango, olives, coffee, cacao, tea, soft fruit, banana, cooking banana, almond, walnut, pecan, hazelnut, pistachio trees, oil palms, rubber trees); optionally in permanent crops and/or on one or more areas of permanent crops and/or in rice crops.

7. A product comprising the herbicide combination defined in claim 1 for controlling unwanted vegetation.
